(19) United States
(12) Patent Application Publication
(10) Pub. No.: US 2015/0057579 A1
(43) Pub. Date: Feb. 26, 2015

(54) Freezable rolling massage device

(71) Applicant: William James Martinez, Austin, TX (US)

(72) Inventor: William James Martinez, Austin, TX (US)

(21) Appl. No.: 13/987,733

(22) Filed: Aug. 26, 2013

(51) Int. Cl. A61H 15/02

(52) U.S. Cl. CPC A61H 15/02; A61H 2015/0014
USPC 601/19

(57) ABSTRACT

The invention is a massage device with a freezable contoured polymer roller whose surface is textured with an array of rounded protrusions. The device is a hand-held aid to massaging of a human body. The main body roller of the massage device contain a non-toxic refrigerant gel and thus can be frozen and remain cold while the person is massaged.

### BACKGROUND OF THE INVENTION

The invention is for creating a freezable massage roller device. It is known there are rolling massage devices with and without textured surfaces. Additionally, there are ice-packs and heat packs for physical therapy. This invention addresses the need to conveniently provide the relief and benefits of massage and cold therapy. The device would be placed in the freezer before use and allowed to cool. When the device is in use it would remove heat, or cool, the portion of the body that is being massaged by way of thermal conduction.

### SUMMARY OF THE INVENTION

It is one object of this invention to be used in massaging portions of a person's body. Another object of this invention is to cool the portion of the person's body which is being massaged by way of thermal conduction.

It is a further object of this invention that it be reusable and re-freezable. Other objects and features of the invention will become apparent within the following description of the invention.

The invention provides a freezable rolling massage device that includes: a textured and contoured hollow polymer massage roller which is filled with a refrigerant gel; and the means to be reused and cleaned with minimal effort and tools.

It is to be noted that this specification of the invention contains no new matter in relation to the previous iterations.

### BRIEF DESCRIPTION OF THE DRAWINGS

To better understand the operation and use of the invention, it will be described by the following drawings:

FIG. 1 is a perspective view of the device;

FIG. 2 is a left view of the device;

FIG. 3 is a front view of the device;

FIG. 4 is a left view of the device for section view reference;

FIG. 5 is a front section view.

### DETAILED DESCRIPTION OF THE INVENTION

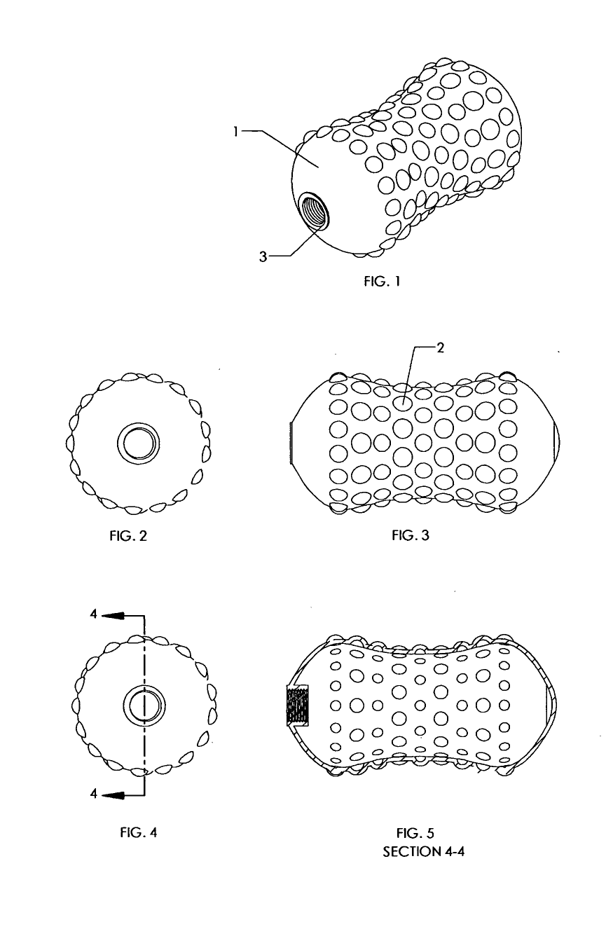

Referring to FIG. 1 of the drawings, the main body roller 1 is a hollow polymer roller filled with a refrigerant gel and is textured by an array of rounded protrusions 2. The refrigerant gel is sealed in the main body roller with a cap 3 on one end. The cap 3 is attached to the main body roller by a threaded connection.

What is claimed is:

1. A freezable rolling massage device comprising of a handle with two protruding symmetric bars holding a main massage body roller that rotates in the direction of travel.

2. A freezable rolling massage device according to claim 1, wherein said main body roller is attached to device by bars protruding from the handle in a Y-shape;
providing a compressive force and pinching the main body roller creating an axis of rotation, with a friction bearing surface created at the junction of the bar-ends and indentions of the main body roller.

3. A freezable rolling massage device according to claim 2, wherein said main body roller is a hollow polymer and contains a non-toxic refrigerant gel.

4. A freezable rolling massage device according to claim 2, wherein said main body surface is covered in a textured array of rounded protrusions to aid in the massage.

5. A freezable rolling massage device according to claim 1, wherein said symmetric bars are connected by interference fit to the handle, lie in the same plane, provide a compressive force at their terminations when the main body roller is pinched in-between, and are made of a steel alloy whose surface is smooth and protected from corrosion.

6. A freezable rolling massage device according to claim 1, wherein said handle is ergonomically shaped such that there exist a recess for the thumb or index finger.
